(19) United States
(12) Patent Application Publication
(10) Pub. No.: US 2013/0083888 A1
(43) Pub. Date: Apr. 4, 2013

(54) APPARATUS FOR DETECTING VOLUME OF FOREIGN SUBSTANCE EXISTED IN CORE OF GEOLOGICAL SAMPLE USING COMPUTER TOMOGRAPHY APPARATUS AND METHOD THEREOF

(71) Applicants: Jae Hwa Jin, Daejeon (KR); Jun Ho Kim, Jeonnam (KR); Min Jun Kim, Daejeon (KR); Han Seok Kim, Gyeonggi-do (KR); Chin Kun Park, Gyeonggi-do (KR); Young Duck Jin, Gyeonggi-do (KR); Myoung Hun Yoon, Seoul (KR)

(72) Inventors: Jae Hwa Jin, Daejeon (KR); Jun Ho Kim, Jeonnam (KR); Min Jun Kim, Daejeon (KR); Han Seok Kim, Gyeonggi-do (KR); Chin Kun Park, Gyeonggi-do (KR); Young Duck Jin, Gyeonggi-do (KR); Myoung Hun Yoon, Seoul (KR)

(21) Appl. No.: 13/322,078

(22) PCT Filed: Sep. 29, 2011
(86) PCT No.: PCT/KR2011/007176

§ 371 Date: Nov. 22, 2011

(51) Int. Cl. G01N 23/04

(52) U.S. Cl. 378/19

(57) ABSTRACT

An apparatus for detecting a volume of a foreign substance existed in a core of a geological sample using a computer tomography apparatus and a method thereof, more particularly an apparatus for detecting a volume of a foreign substance existed in a core of a geological sample using a computer tomography apparatus and a method thereof capable of calculating a volume of any one object among the foreign substance existed in the core.

### TECHNICAL FIELD

The present invention relates to an apparatus for detecting a volume of a foreign substance existed in a core of a geological sample using a computer tomography apparatus and a method thereof, more particularly to an apparatus for detecting a volume of a foreign substance existed in a core of a geological sample using a computer tomography apparatus and a method thereof capable of calculating a volume of any one object among the foreign substance existed in the core.

### BACKGROUND ART

In general computer tomography apparatus (CT) for medical purposes shown in FIG. 1, a CT beam, which is transmitted by CT beam transmittance part 10, passes through an object 30 and signals passing through the object are detected by a detector, so that the object is restored as three-dimensional images by using the signals to output them to an user.

In case of the above manner, since the three-dimensionally restored object is randomly cut and only the cut planar images are checked, it cannot effectively calculate of the volume of a specific part existed in the inside of the photographed object.

Meanwhile, in case of an industrial computer tomography apparatus (CT), since it is mainly used to observe the defective part such as a flaw or a crack etc. existed in the inside of the product, the measuring method of the volume of the specific part existed in the inside of the photographed object remains an unsolved issue for a long time.

Occasionally, where the size or the diameter of the specific part of the object is numerically measured at any cost, since it is necessary to operate a separate reverse modeling program, there are problems in that it involves the additional time and cost.

In the meantime, a boring sample of a cylindrical type, that is, a core acquired by the drilling of the geological strata in the field of geological resources related to the present invention is considered critical, because the component distribution, which is existed in the inside thereof, reflects the distribution of the component of the entire geological strata.

Accordingly, in the field of geological resources, where a specific material is found in the core, it is necessary to grasp the component thereof as well as measure the volume thereof.

In a general method of measuring the volume of the specific material existed in the core in the field of geological resources, it takes a sample existed in the measuring core and the gap is filled with a gas or water etc. and then, it can be calculated based on the total content in that the water or the gas is consumed.

However, in the conventional method, the core can be easily damaged. Also, there are problems in that it involves considerable time and cost.

Recently, a CT scan of the core sample has been increased. However, a method of effectively measuring the volume of the specific part existed in the inside of the core has not been developed yet based on the CT scan.

After all, it demands an apparatus capable of measuring the volume of the specific part existed in the core after the core is scanned through the computer tomography apparatus (CT).

### DISCLOSURE

### Technical Problem

Therefore, the present invention has been made in view of the above-mentioned problems, and the object of the present invention is to provide an apparatus for detecting a volume of a foreign substance existed in a core of a geological sample using a computer tomography apparatus and a method thereof capable of calculating a volume of any one object among the foreign substance existed in the core.

Another object of the present invention is to provide an apparatus for detecting a volume of a foreign substance existed in a core of a geological sample using a computer tomography apparatus and a method thereof capable of effectively calculating an area of a specific material in one slice cut in the direction of a major axis and the vertical direction of the core through a easy computer calculation.

Further another object of the present invention is to provide an apparatus for detecting a volume of a foreign substance existed in a core of a geological sample using a computer tomography apparatus and a method thereof in that because the core of the cylindrical shape has a predetermined diameter, a calculating method of the slice area is applied along the major axis of the core in a lump, thereby precisely measuring the volume of the specific material.

### Technical Solution

In accordance with the present invention to achieve the object thereof, there is provided an apparatus for detecting a volume of a foreign substance existed in a core of a geological sample using a computer tomography apparatus comprising: a CT beam transmission part 10 for transmitting a CT beam to a core 110 of a geological sample rotated by a rotation motor; a core fixing part 120 for fixing the core 110 thereto; the rotation motor 130 for rotating the core fixing part 120 to which the core 110 is fixed; a detector 200 for acquiring the CT beam transmitted through the CT beam transmission part 10; an image acquisition part 510 for acquiring slice images analyzed by the detector 200; an image storing part 560 for storing the slice images acquired by the image acquisition part 510; a count range acquisition part 520 for acquiring a count range for measuring the volume; a gray level range acquisition part 530 for acquiring a gray level range of any one object existed in the slice; a central controller 550 for receiving the count range acquired by the count range acquisition part 520 and the gray level range acquired by the gray level range acquisition part 530 and counting a number of pixels corresponding to the gray level range; and a report output part 540 for outputting results processed by the central controller 550.

### Advantageous Effects

According to the apparatus for detecting the volume of the foreign substance existed in the core of the geological sample using the computer tomography apparatus and the method thereof, there is an effect in that the volume of any one object among the foreign substance existed in the core can be calculated by using the computer tomography apparatus.

Also, in the volume detecting method according to the present invention, if the gaps between the slices are infinitely narrow, the volume thereof can be precisely measured in theory. Accordingly, it can derive the same volume value as other exact volume measuring methods.

Especially, where it is difficult to be applied to other volume measuring methods, the volume detecting method according to the present invention can be effectively applied.

Also, in case of the core, since the existence of the foreign substance in the core can be understood, the volume detecting method according to the present invention can be also effectively applied.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is an example view illustrating a conventional computer tomography apparatus;

FIG. 2 is a block diagram illustrating an example of rotating a core of an apparatus for detecting a volume of a foreign substance existed in the core of a geological sample using a computer tomography apparatus according to one embodiment of the present invention;

FIG. 3 is an example view illustrating a plurality of slices of an apparatus for detecting a volume of a foreign substance existed in the core of a geological sample using a computer tomography apparatus according to one embodiment of the present invention;

FIG. 4 is an example view illustrating foreign substances contained in a plurality of slices of an apparatus for detecting a volume of a foreign substance existed in the core of a geological sample using a computer tomography apparatus according to one embodiment of the present invention;

FIG. 5 is a photograph illustrating foreign substances contained in a plurality of slices of an apparatus for detecting a volume of a foreign substance existed in the core of a geological sample using a computer tomography apparatus according to one embodiment of the present invention;

FIG. 6 is an example view illustrating a count range designated by a user in an apparatus for detecting a volume of a foreign substance existed in the core of a geological sample using a computer tomography apparatus according to one embodiment of the present invention;

FIG. 7 is a photograph illustrating a count range designated by a user in an apparatus for detecting a volume of a foreign substance existed in the core of a geological sample using a computer tomography apparatus according to one embodiment of the present invention;

FIG. 8 is a reference view for explaining the slice corresponding to an error area of an apparatus for detecting a volume of a foreign substance existed in the core of a geological sample using a computer tomography apparatus according to one embodiment of the present invention;

FIG. 9 is a block diagram illustrating an apparatus for detecting a volume of a foreign substance existed in the core of a geological sample using a computer tomography apparatus according to one embodiment of the present invention;

FIG. 10 is an example view illustrating a concentration detected by an apparatus for detecting a volume of a foreign substance existed in the core of a geological sample using a computer tomography apparatus according to one embodiment of the present invention;

FIG. 11 is an example view illustrating a concentration measuring example of any one substance in an apparatus for detecting a volume of a foreign substance existed in the core of a geological sample using a computer tomography apparatus according to one embodiment of the present invention;

FIG. 12 is an example view illustrating slices during the concentration measuring of any one substance in an apparatus for detecting a volume of a foreign substance existed in the core of a geological sample using a computer tomography apparatus according to one embodiment of the present invention;

FIG. 13 is a flow chart illustrating a method for detecting a volume of a foreign substance existed in the core of a geological sample using a computer tomography apparatus according to one embodiment of the present invention; and

FIG. 14 is a photograph illustrating process steps through a method for detecting a volume of a foreign substance existed in the core of a geological sample using a computer tomography apparatus according to one embodiment of the present invention.

### DESCRIPTIONS ON REFERENCE NUMBERS FOR THE MAJOR COMPONENTS IN THE DRAWINGS

110: core
500: apparatus for detecting volume of foreign substance
510: image acquisition part
520: count range acquisition part
530: gray level range acquisition part
540: report output part
550: central controller
560: image storing part

### BEST MODE

### Mode for Invention

Hereinafter, exemplary embodiments of the present invention will be described in detail with reference to the accompanying drawings.

An apparatus for detecting a volume of a foreign substance existed in a core of a geological sample using a computer tomography apparatus according to the present invention includes an image acquisition part 510 for acquiring slice images analyzed by a detector 200, an image storing part 560 for storing the slice images acquired by the image acquisition part 510, a count range acquisition part 520 for acquiring a count range for measuring the volume, a gray level range acquisition part 530 for acquiring a gray level range of any one object existed in the slice, a central controller 550 for receiving the count range acquired by the count range acquisition part 520 and the gray level range acquired by the gray level range acquisition part 530 and counting a number of pixels corresponding to the gray level range, and a report output part 540 for outputting results processed by the central controller 550.

At this time, the central controller 550 serves to calculate the number of the pixels within the count range, the number of the pixels of the object corresponding to the gray level, and a concentration of a specific object per the slices with reference to the calculated number of the pixels.

Also, the central controller 550 serves to vertically delete the number of the slices belonging to error areas among the slice images, acquired by the image acquisition part 510 and then, store only the remaining slice images in the image storing part 560.

Moreover, the central controller 550 serves to regard any object having another gray level range other than the gray level range of any one object acquired by the gray level range acquisition part 530 as another object.

In the meantime, a method for detecting a volume of a foreign substance existed in a core of a geological sample using a computer tomography apparatus includes a slice image acquiring step S100 of acquiring slice images analyzed by a detector 200 through an image acquisition part 510, a slice image storing step S110 of

storing the slice images acquired by the image acquisition part 510 in an image storing part 560, a count range acquiring step S120 of acquiring a count range for measuring the volume through a count range acquisition part 520, a gray level range acquiring step S130 of acquiring a gray level range of any one object existed in the slice through a gray level range acquisition part 530, a pixel number counting step S140 of receiving the count range acquired by the count range acquisition part 520 and the gray level range acquired by the gray level range acquisition part 530 through a central controller 550 and counting a number of pixels corresponding to the gray level range, and a report output step S150 of outputting results processed by the central controller 550 through a report output part 540.

At this time, the central controller 550 serves to calculate the number of the pixels within the count range, the number of the pixels of the object corresponding to the gray level, and a concentration of a specific object per the slices with reference to the calculated number of the pixels.

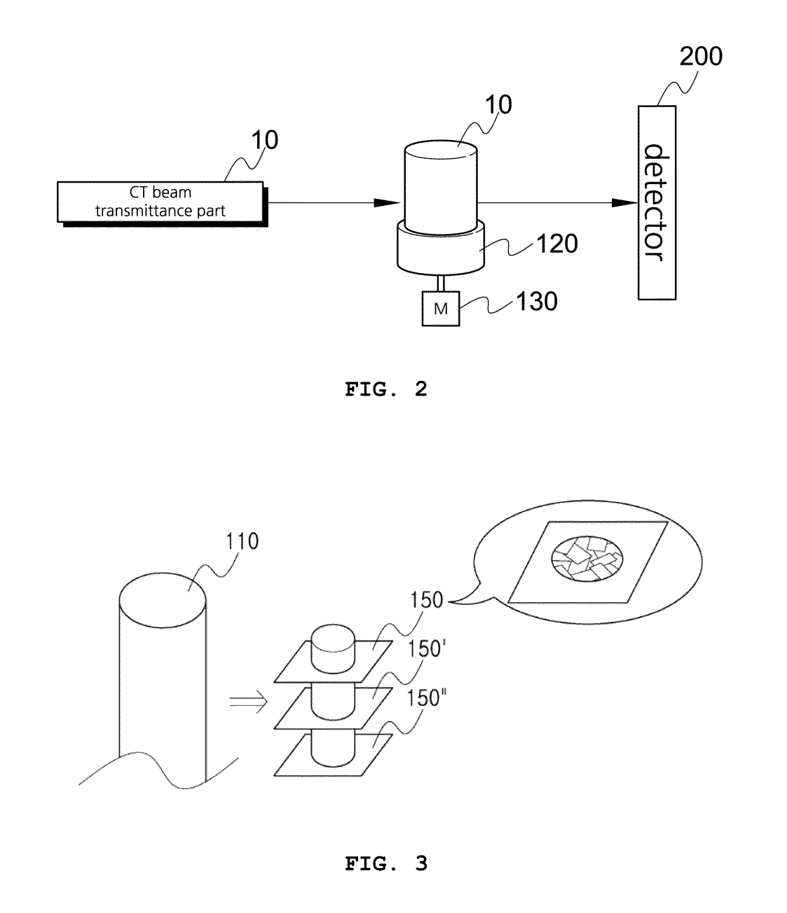

FIG. 2 is a block diagram illustrating an example of rotating a core of an apparatus for detecting a volume of a foreign substance existed in the core of a geological sample using a computer tomography apparatus according to one embodiment of the present invention.

As shown in FIG. 2, the apparatus for detecting the volume of the foreign substance existed in the core of the geological sample using the computer tomography apparatus according to one embodiment of the present invention includes a CT beam transmission part 10, a core 110, a core fixing part 120, a rotation motor 130, and a detector 200.

The CT beam, which is transmitted by the CT beam transmission part 10, is detected by the detector 200 through the core 110, which is an object, and then, the detected CT beam is outputted to a user.

Here, the core fixing part 120 serves to fix the core 110 thereto and then, prevent the core from being deviated during rotation thereof.

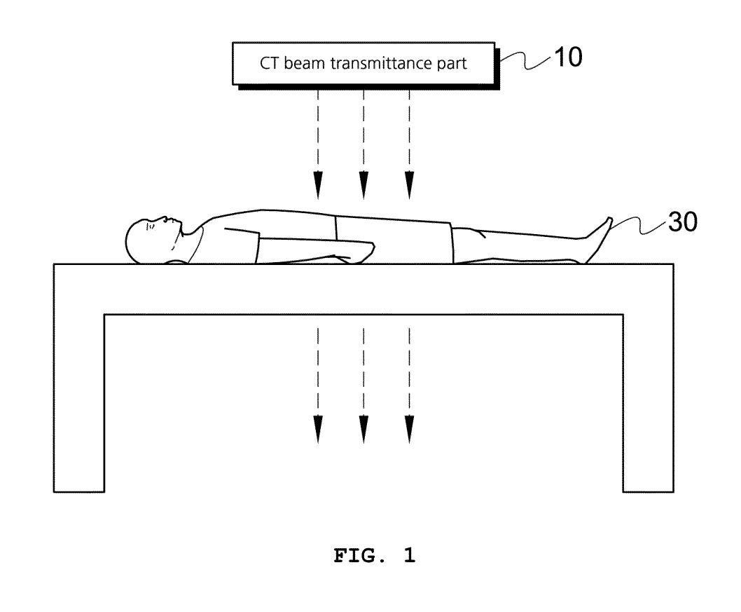

In case of the conventional detector as shown in FIG. 1, it adopts a rotation manner of a bent detector, not a rotation manner of the object. However, the present invention adopts a rotation of the core.

Accordingly, the apparatus for detecting the volume of the foreign substance existed in the core of the geological sample using the computer tomography apparatus according to one embodiment of the present invention includes the rotation motor 130 for rotating the core 110 and the core fixing part 120 for preventing the core from being deviated during the rotation thereof.

The reason for rotating the core 110 is because that it requires the images detected at various angles so as to accurately measure the volume of the foreign substance existed in the core.

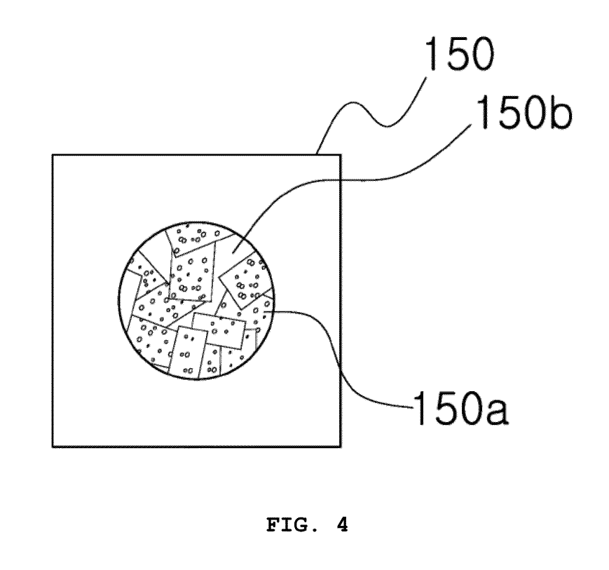

FIG. 3 is an example view illustrating a plurality of slices of an apparatus for detecting a volume of a foreign substance existed in the core of a geological sample using a computer tomography apparatus according to one embodiment of the present invention.

FIG. 4 is an example view illustrating foreign substances contained in a plurality of slices of an apparatus for detecting a volume of a foreign substance existed in the core of a geological sample using a computer tomography apparatus according to one embodiment of the present invention.

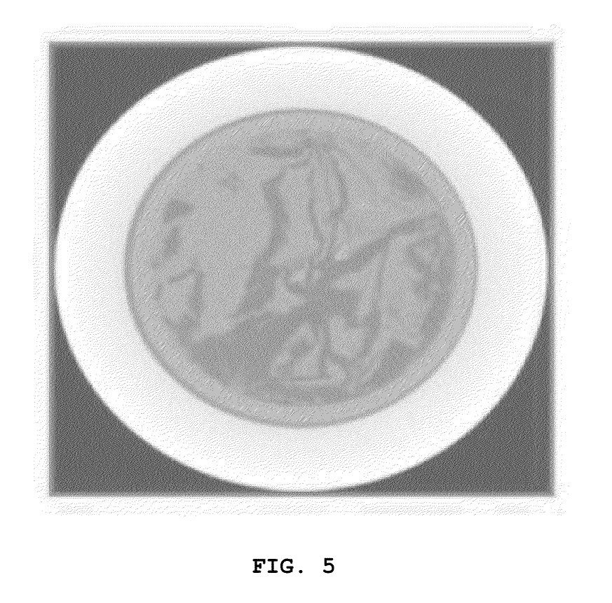

FIG. 5 is a photograph illustrating foreign substances contained in a plurality of slices of an apparatus for detecting a volume of a foreign substance existed in the core of a geological sample using a computer tomography apparatus according to one embodiment of the present invention.

As shown in FIG. 3, the images acquired through the detector 200 according to the present invention include a plurality of slices 150, 150′, and 150″.

As shown in FIG. 4 and FIG. 5, the slice 150 includes an object 1 (150a) and an object 2 (150b).

The distribution of the object 2 (150b) can be calculated within the object 1 (150a). Here, the object 2 (150b) may be the foreign substance or vain spaces.

FIG. 5 is a photograph illustrating the foreign substance in the actual slice images. Accordingly, it can check the distribution between the objects.

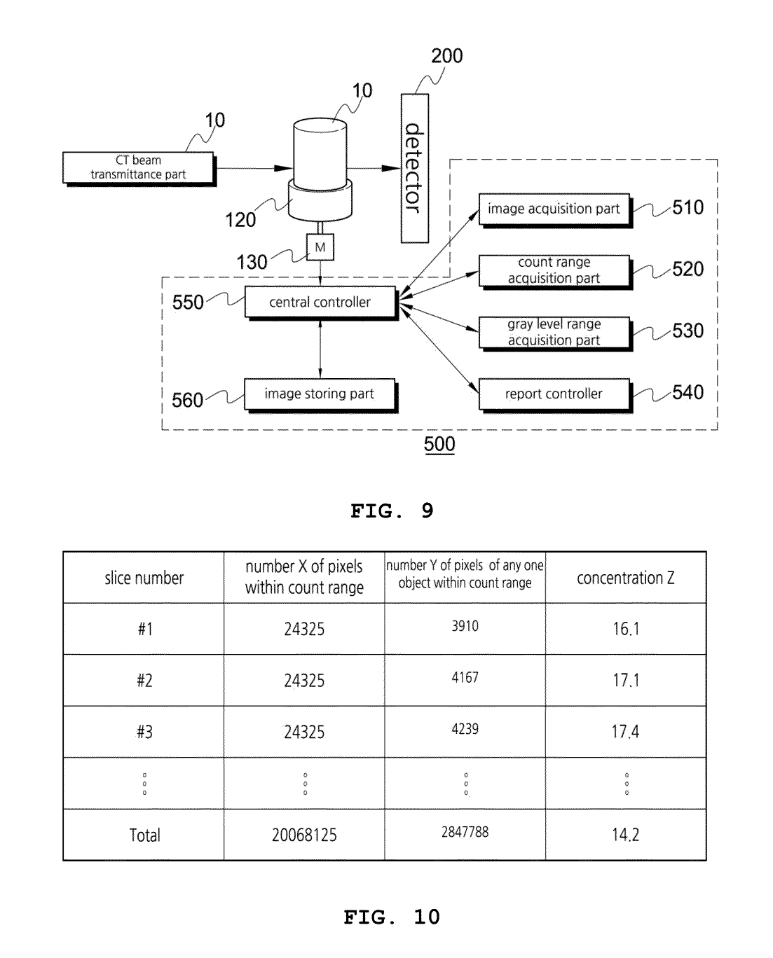

FIG. 9 is a block diagram illustrating an apparatus for detecting a volume of a foreign substance existed in the core of a geological sample using a computer tomography apparatus according to one embodiment of the present invention.

The apparatus 500 for detecting the volume of the foreign substance existed in the core of the geological sample using the computer tomography apparatus according to the present invention includes the image acquisition part 510 for acquiring the slice images analyzed by the detector 200, the image storing part 560 for storing the slice images acquired by the image acquisition part 510, the count range acquisition part 520 for acquiring the count range for measuring the volume, the gray level range acquisition part 530 for acquiring the gray level range of any one object existed in the slice, the central controller 550 for receiving the count range acquired by the count range acquisition part 520 and the gray level range acquired by the gray level range acquisition part 530 and the counting number of the pixels corresponding to the gray level range, and the report output part 540 for outputting the results processed by the central controller 550.

Since the data processing techniques of the detector 200 and the operation thereof are already well-known in the art, further descriptions on these are omitted here.

The slice images acquired by the image acquisition part are shown in FIG. 4 and FIG. 5.

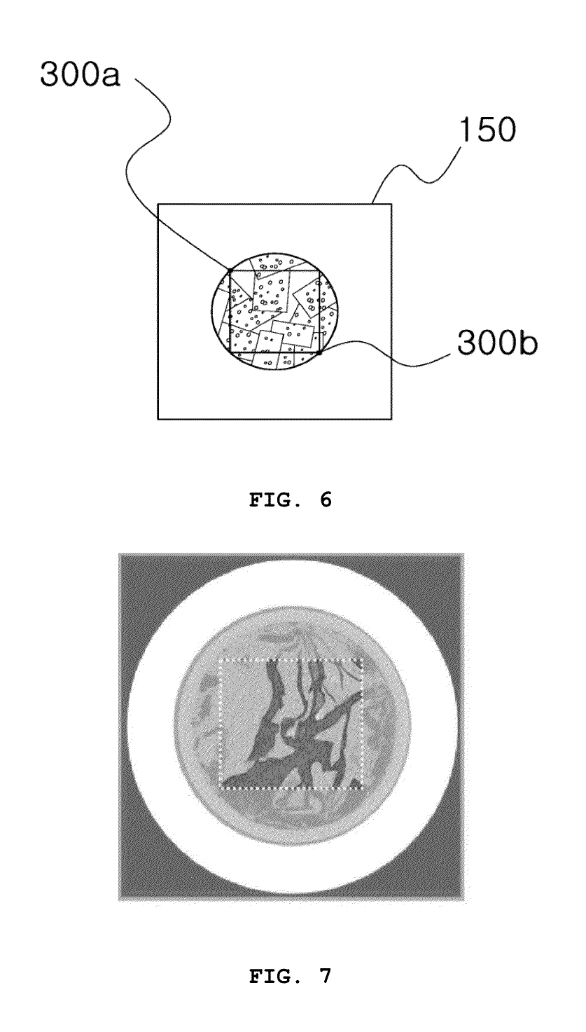

FIG. 6 is an example view illustrating a count range designated by a user in an apparatus for detecting a volume of a foreign substance existed in the core of a geological sample using a computer tomography apparatus according to one embodiment of the present invention.

FIG. 7 is a photograph illustrating a count range designated by a user in an apparatus for detecting a volume of a foreign substance existed in the core of a geological sample using a computer tomography apparatus according to one embodiment of the present invention.

As shown, the slice images stored in the image storing part 560 are outputted to a monitor of the user, so that he can designate the count range. Here, in order to designate the count range, the slice images are outputted to the monitor through a volume measuring program.

Where the corresponding slice is outputted to the monitor so as to designate the count range, as shown in FIG. 6 and FIG. 7, for example, the user can designate a left upper end point 300a and a right lower end point 300b, thereby acquiring the count range in the count range acquisition part 520.

Accordingly, as shown in FIG. 7, the designated range can be checked in the actual photograph.

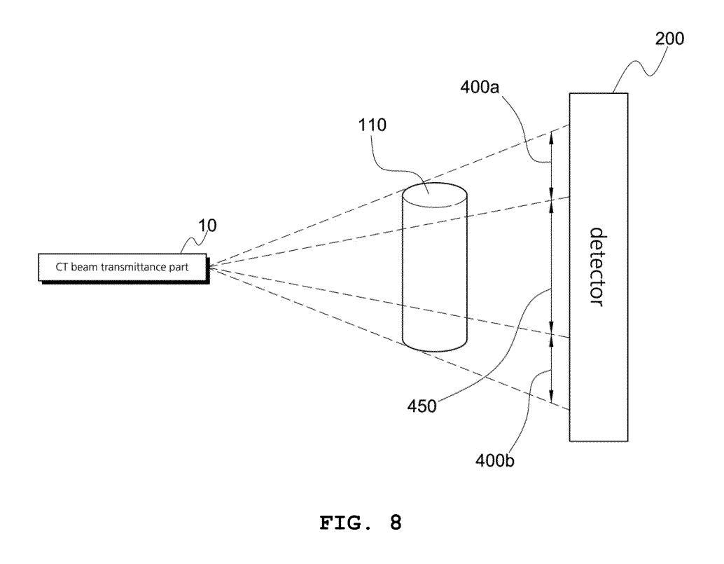

FIG. 8 is a reference view for explaining the slice corresponding to an error area of an apparatus for detecting a volume of a foreign substance existed in the core of a geological sample using a computer tomography apparatus according to one embodiment of the present invention.

As shown in FIG. 8, where the core is treated as the slices, for example, if the number of the slices is 1024, the study confirmed that the number of the slices belonging to the error areas 400a and 400b should be deleted, thereby increasing the accuracy thereof. That is, since it is necessary to delete each of 100 slices belonging to the upper and lower error areas, the total slices of 200 should be deleted.

That is, the upper most slice images 400a and the lowermost slice images 400b belonging to the error areas are deleted.

Accordingly, the number of the remaining slices is 824, except for the error slices from the total slices.

The error slices belonging to the error areas among the slice images acquired by the image acquisition part 510 are vertically deleted by the central controller 550 and then, only the slice images belonging to the measuring area 450 are stored in the image storing part 560.

That is, the upper most slice images 400a and the lowermost slice images 400b belonging to the error areas are deleted and then, only the remaining slice images 450 are stored in the image storing part 560.

After all, the slices of 824 can be utilized.

Also, after the user designates the count rage, the gray level range of any one object existed in the slice is designated. At this time, the user can designate the gray level range through the observation of the gray level pixels.

For example, where the gray level of the object for measuring the volume thereof is designated in the range of 0 to 1100, the central controller 550 judges that the gray level in excess of 1,100 is regarded as another object other than the measuring object.

That is, the central controller 550 serves to regard any object having another gray level range other than the gray level range of any one object acquired by the gray level range acquisition part 530 as another object.

The slice images existed in the range of the count are displayed on the user's monitor. That is, the slice images are displayed in the monitor through the volume measuring program in order that the user can designate the gray level thereof.

Where the user designates the gray level thereof through the monitor, the gray level range of any one object existed in the slice is acquired through the gray level range acquisition part 530.

At this time, the central controller 550 serves to receive the count range acquired by the count range acquisition part 520 and the gray level range acquired by the gray level range acquisition part 530 and count numbers of pixels corresponding to the gray level range.

Thereafter, the results processed by the central controller 550 are displayed on the monitor through the report output part 540. As shown in FIG. 10, in case of a slice #1, it can be seen that the number X of the pixels within the count range is 24,325 and the number Y of the pixels of any one object within the count range is 3,910 through the calculation of the central controller 550. Also, it was analyzed that the concentration (Z=(Y/X) 100%) of any one object of the corresponding slice is 16.07%.

Also, in case of a slice #2, it can be seen that the number X of the pixels within the count range is 24,325 and the number Y of the pixels of any one object within the count range is 4,167 through the calculation of the central controller 550. Also, it was analyzed that the concentration (Z=(Y/X)×100%) of any one object of the corresponding slice is 17.01%.

Here, it can be seen that the total number X of the pixels within the count range of the total slices is 20,068,125 and the total number Y of the pixels of any one object within the count range is 2,847,788 through the calculation of the central controller 550. Also, it was analyzed that the average concentration (Z=(Y/X)×100%) of any one object of the corresponding slice is 14.02%.

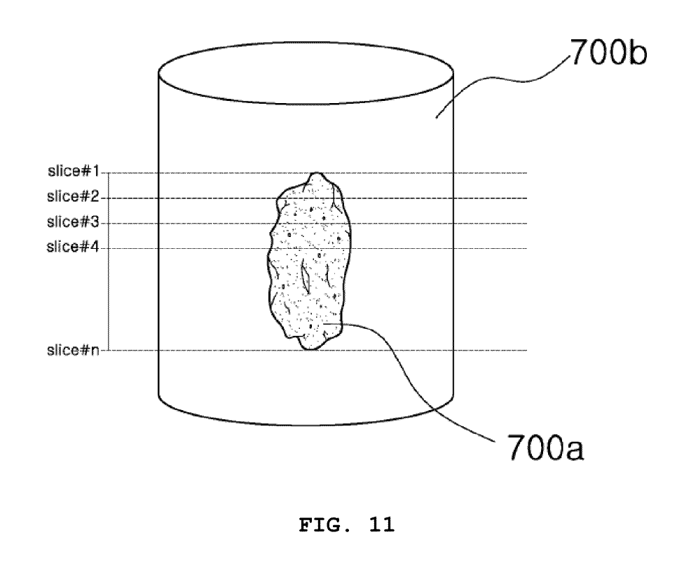

FIG. 11 is an example view illustrating a concentration measuring example of any one substance in an apparatus for detecting a volume of a foreign substance existed in the core of a geological sample using a computer tomography apparatus according to one embodiment of the present invention.

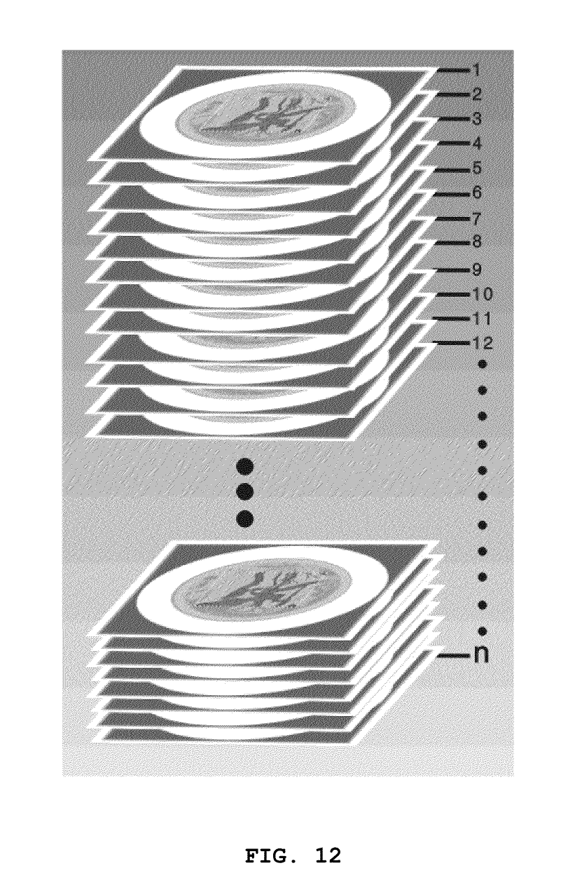

FIG. 12 is an example view illustrating slices during the concentration measuring of any one substance in an apparatus for detecting a volume of a foreign substance existed in the core of a geological sample using a computer tomography apparatus according to one embodiment of the present invention.

Referring to FIG. 11 and FIG. 12, where the slice images detected through the detector 200 are acquired and the user designates the count range from the slice images, the concentration of the specific object is calculated within the corresponding count range.

As shown in FIG. 12, where the plurality of the slice images is acquired, the concentration of the specific object is calculated within the corresponding count range designated by the user.

That is, so as to measure the concentration of a fossil 700a existed in a mud 700b, the gray level of the fossil 700a is designated.

At this time, the gray level of the fossil 700a is designated in the range of 0 to 25,000, it is judged that the gray level in excess of the designated range is regarded as the mud 700b and the concentration of the fossil is analyzed per each slice.

The operation between each element of the apparatus according to the present invention will be concretely explained in the following method.

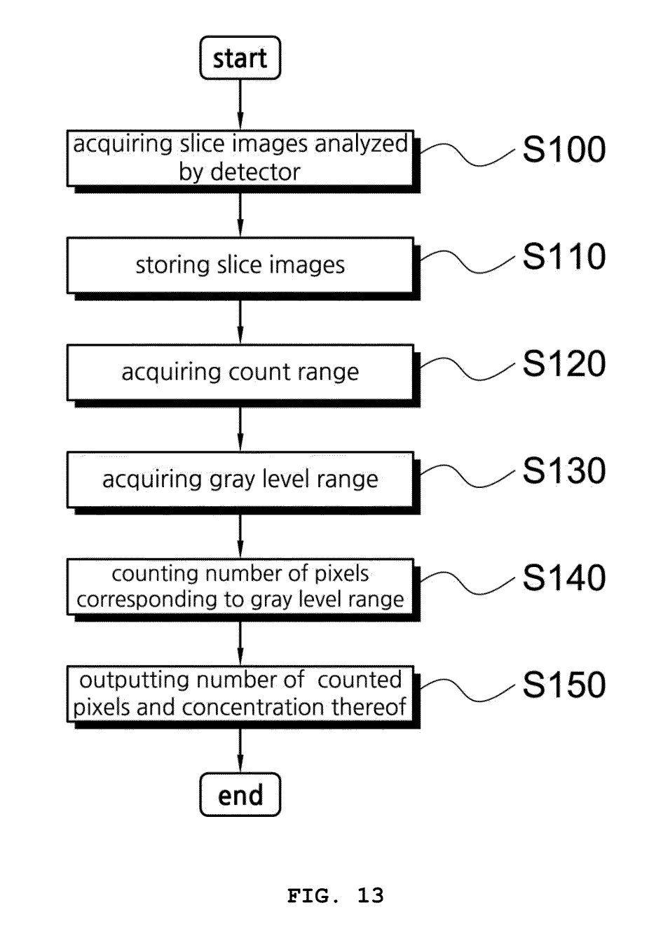

FIG. 13 is a flow chart illustrating a method for detecting a volume of a foreign substance existed in the core of a geological sample using a computer tomography apparatus according to one embodiment of the present invention.

As shown in FIG. 13, the method for detecting the volume of the foreign substance existed in the core of the geological sample using the computer tomography apparatus includes a slice image acquiring step S100 of acquiring slice images analyzed by a detector 200 through an image acquisition part 510, a slice image storing step S110 of storing the slice images acquired by the image acquisition part 510 in an image storing part 560, a count range acquiring step S120 of acquiring a count range for measuring the volume through a count range acquisition part 520, a gray level range acquiring step S130 of acquiring a gray level range of any one object existed in the slice through a gray level range acquisition part 530, a pixel number counting step S140 of receiving the count range acquired by the count range acquisition part 520 and the gray level range acquired by the gray level range acquisition part 530 through a central controller 550 and counting a number of pixels corresponding to the gray level range, and a report output step S150 of outputting results processed by the central controller 550 through a report output part 540.

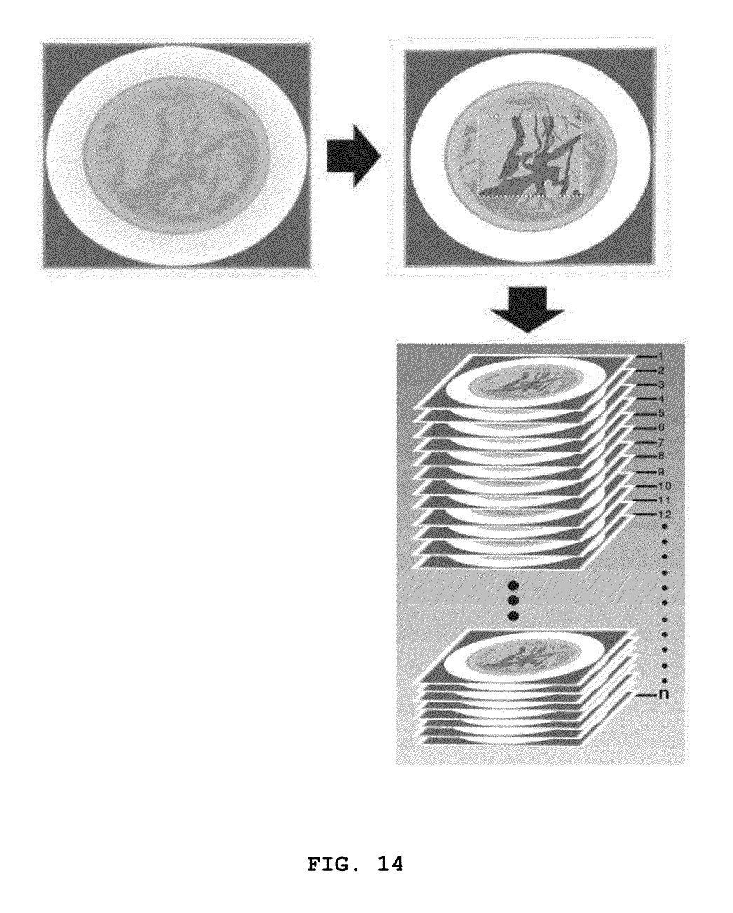

In the slice image acquiring step S100, the slice images analyzed by the detector 200 are acquired. Also, in the slice image storing step S110, the slice images acquired by the image acquisition part 510 are stored in the image storing part 560 though the central controller 560 (note FIG. 14).

In the count range acquiring step S120, the count range for measuring the volume is acquired through the count range acquisition part 520. Also, in the gray level range acquiring step S130, the gray level range of any one object existed in the slice is acquired through the gray level range acquisition part 530.

Thereafter, the pixel number counting step S140 is conducted. Concretely, the count range acquired by the count range acquisition part 520 and the gray level range acquired by the gray level range acquisition part 530 are received through the central controller 550 and the number of pixels corresponding to the gray level range is counted.

The central controller 550 explained in the present invention serves to control the flow of the signals among the image acquisition part 510, the count range acquisition part 520, the gray level range acquisition part 530, and the report output part 540.

At this time, the central controller 550 serves to calculate the number of the pixels within the count range designated by the user. Also, central controller 550 serves to calculate the number of the pixels of the object corresponding to the gray level designated by the user, the concentration of the specific object per the slices with reference to the calculated number of the pixels, and the average concentration of the specific object.

Finally, the method for detecting the volume of the foreign substance existed in the core of the geological sample using the computer tomography apparatus is completed through the report output step S150 of outputting results processed by the central controller 550 through a report output part 540.

According to the construction and the operation of the apparatus for detecting the volume of the foreign substance existed in the core of the geological sample using the computer tomography apparatus, there is an effect in that the volume of any one object among the foreign substance existed in the core can be calculated by using the computer tomography apparatus.

Also, in the volume detecting method according to the present invention, if the gaps between the slices are infinitely narrow, the volume thereof can be precisely measured in theory. Accordingly, it can derive the same volume value as other exact volume measuring methods.

Although several exemplary embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention relates to an apparatus for detecting a volume of a foreign substance existed in a core of a geological sample using a computer tomography apparatus and a method thereof, more particularly to an apparatus for detecting a volume of a foreign substance existed in a core of a geological sample using a computer tomography apparatus and a method thereof capable of calculating a volume of any one object among the foreign substance existed in the core.

1. An apparatus for detecting a volume of a foreign substance existed in a core of a geological sample using a computer tomography apparatus comprising:
a CT beam transmission part for transmitting a CT beam to a core of a geological sample rotated by a rotation motor;
a core fixing part for fixing the core thereto;
the rotation motor for rotating the core fixing part to which the core is fixed;
a detector for acquiring the CT beam transmitted through the CT beam transmission part;
an image acquisition part for acquiring slice images analyzed by the detector;
an image storing part for storing the slice images acquired by the image acquisition part;
a count range acquisition part for acquiring a count range for measuring the volume;
a gray level range acquisition part for acquiring a gray level range of a specific object in the slice;
a central controller for receiving the count range acquired by the count range acquisition part and the gray level range acquired by the gray level range acquisition part, counting a number of all pixels within the count range, detecting gray level of each of the all pixels within the count range, and counting a number of pixels having a gray level within the received gray level range; and
a report output part for outputting results processed by the central controller.

2. The apparatus as recited in claim 1, wherein the central controller calculates a concentration of the specific object per the slices with reference to a ratio of the number of pixels within the received gray level range to the number of all pixels within the count range.

3. The apparatus as recited in claim 1, wherein the slice images include upper slice images corresponding to a predetermined upper part of the core and lower slice images corresponding to a predetermined lower part of the core and middle slice images between the upper and lower slice images, and the central controller deletes the upper slice images and the lower slice images and then, only the remaining slice images are stored in the image storing part.

4. The apparatus as recited in claim 1, wherein the central controller regards pixels having a gray level beyond the received gray level range as pertaining to an object other than the specific object.

5. A method for detecting a volume of a foreign substance existed in a core of a geological sample using a computer tomography apparatus comprising:
a slice image acquiring step of acquiring slice images analyzed by a detector through an image acquisition part;
a slice image storing step of storing the slice images acquired by the image acquisition part in an image storing part;
a count range acquiring step of acquiring a count range for measuring the volume through a count range acquisition part;
a gray level range acquiring step of acquiring a gray level range of a specific object in the slice through a gray level range acquisition part;
a pixel number counting step of receiving the count range acquired by the count range acquisition part and the gray level range acquired by the gray level range acquisition part through a central controller, counting a number of all pixels within the count range, detecting gray level of each of the all pixels within the count range, and counting a number of pixels having a gray level within the received gray level range; and
a report output step of outputting results processed by the central controller through a report output part.

6. The method as recited in claim 5, wherein the central controller calculates a concentration of the specific object per the slices with reference to a ratio of the number of pixels within the received gray level range to the number of all pixels within the count range.
